(19) United States
(12) Patent Application Publication
(10) Pub. No.: US 2003/0202224 A1
(43) Pub. Date: Oct. 30, 2003

(54) Image pick-up device

(75) Inventor: Yoshinobu Moriya, Tokyo (JP)

Correspondence Address: SUGHRUE MION, PLLC, 2100 PENNSYLVANIA AVENUE, N.W., WASHINGTON, DC, 20037, US

(73) Assignee: NEC VIEWTECHNOLOGY, LTD.

(21) Appl. No.: 10/419,738

(22) Filed: Apr. 22, 2003

(30) Foreign Application Priority Data
Apr. 25, 2002 (JP) 123808/2002

(51) Int. Cl. H04N 1/04; H04N 1/10; H04N 1/195

(52) U.S. Cl. 358/475; 358/479

(57) ABSTRACT

An image pick-up device includes an image pick-up unit 3 for shooting a subject 2 in a desired direction, a light source unit composed of a circular type cold-cathode tube 4 fixed to a predetermined portion of the image pick-up unit 3 in such a way that an illuminating direction of the light source unit 3 is substantially coincident with a shooting direction of the image pick-up unit 4 and a support light source unit 5 housed in an arm 6 for supporting the image pick-up unit 3. The subject 2 to be shot by the image pickup unit 3 is always illuminated with light from the circular type cold-cathode tube 4.

### BACKGROUND OF THE INVENTION

1. Field of the Invention

The present invention relates an image pick-up device and, in particular, to an image pick-up device (picture and calligraphic camera) for providing an optical image (digital data) representative of photo, book, document, teaching material, solid material or similar subject to an external device as an input image thereof.

2. Description of the Prior Art

An image pick-up device for providing an image of a subject kept at hand to an output device such as CRT, liquid crystal display or projector or an external device of such as a computer has been known. Since such image pick-up device can enlarge and project an image of a subject at hand by a liquid crystal projector, it has been popularly utilized by organizations for the purpose of conference and/or presentation. In utilizing the image pick-up device of such kind, it is usual to extinguish illumination of a room, irradiate the subject laid on the image pick-up device with light from a light source mounted thereon and pick-up an image of the subject by means of a camera.

FIG. 1 is a perspective view of a conventional image pick-up device. The image pick-up device shown in FIG. 1 has a box-like construction including a substantially square subject mounting table 101 on which a subject 102 is mounted, an illumination system composed of light source units 104a and 104b arranged on both sides of the subject 102 for illuminating the latter and an image pick-up unit (camera) 103 arranged to look down the subject 102. The light source units 104a and 104b and the image pick-up unit 103 are supported by one ends of arms 105a, 105b and 106, respectively. An arm stage 107 is provided on one edge portion of the subject mounting table 101 and the other ends of the arms 105a and 105b are supported on opposite end portions of a front wall of the arm stage 107, respectively, and the other end of the arm 106 is supported in substantially a center portion of the arm stage 107.

The light source unit 104a takes in the form of a rod-like fluorescent lamp having one end rotatably mounted on the one end portion of the arm 105a. The light source unit 104b has the same structure as that of the light source unit 104a and one end thereof is rotatably mounted on the one end of the arm 105b. The arms 105a and 105b are rotatable in a plane substantially coplanar with the front wall of the arm stage 107, respectively. By regulating rotation angles of the light source units 104a and 104b and the arms 105a and 105b, it is possible to change illuminating angles with respect to the subject 102 within a certain range.

The image pick-up unit 103 is rotatably mounted on the one end portion of the arm 106 and the arm 106 can rotates in a plane orthogonal to the coplanar plane about the center portion of the arm stage 107. By regulating rotation angles of the image pick-up unit 103 and the arm 106, it is possible to change height of the image pick-up unit 103 and a shooting angle of the image pick-up unit 103 with respect to the subject 102 within certain ranges, respectively.

The image pick-up device further includes various functions such as functions necessary for a transmission of an image data taken-in by the image pick-up unit 103 to external output devices such as a projector.

When the subject 102 mounted on the subject mounting table 101 is to be shot by the image pick-up unit 103, a surface of the subject 102, which is to be shot, is illuminated by the light source units 104a and 104b by regulating the angles of the light source units and the angles of the arms 105a and 105b supporting them and then the subject 102 is shot in a desired direction by regulating the angles of the image pick-up unit 103 and the arm stage 107. The image pick-up unit 103 usually has a zooming function and an image data having a suitable size can be obtained by using the zooming function.

FIG. 2 shows another conventional image pick-up device. Although, in the image pick-up device shown in FIG. 1, the illumination system is composed of the light source units 104a and 104b provided on both sides of the subject mounting table 101, an illumination system of the image pick-up device shown in FIG. 2 is composed of only one light source unit 104. Since portions of the image pick-up device shown in FIG. 2 other than the illumination system are the same as those of the image pick-up device shown in FIG. 1, only the illumination system shown in FIG. 2 will be described.

The light source unit 104 is a rod-like fluorescent lamp having one end hinged to substantially a center portion of an arm 106, which supports an image pick-up unit 103, by using a rotary hinge 108, so that the light source unit 104 can rotate about the hinge 108. Therefore, when illumination is unnecessary, the light source unit 104 can be folded up on a backside of the arm 106 by rotating the light source unit 104 about the hinge 108.

However, the conventional image pick-up devices shown in FIG. 1 and FIG. 2 have the following problems.

In the image pick-up device shown in FIG. 1, since the light source units 104a and 104b are mounted on the both sides of the subject mounting plate 101 with the arms 105a and 105b, respectively, there are various limitations in designing the device. When the subject is to be replaced by another subject, the arms 105a and 105b become obstacle for an operator.

Further, in shooting the subject 102, the operator must perform the angle regulation of the light source units 104a and 104b and the arms 105a and 105b in addition to the angle regulations of the image pick-up unit 103 and the arm. 106. This requires a considerable amount of sophisticated work.

In the image pick-up device shown in FIG. 2, the problem that the arm 106 becomes obstacle in changing the subject does not exist since the light source unit 104 is mounted on the arm 106 supporting the image pick-up unit. However, the angle regulations of the image pick-up unit 103 and the arm 106 in addition to the angle regulation of the light source unit 104 in shooting the subject 102 are troublesome.

Further, when the subject 102 takes in the form of, for example, a pipe and an inner surface of the pipe is to be shot, there is a problem that light from the light source unit 104 can not sufficiently illuminate the inner surface of the pipe since positions of the image pick-up unit 103 and the light source unit 104 are considerably different.

### SUMMARY OF THE INVENTION

An object of the present invention is to provide an image pick-up device, which is capable of illuminating even an inner surface of a cylindrical subject such as a pipe and has high freedom in design of the image pick-up device and superior operability thereof.

In order to achieve the above object, an image pick-up device according to the present invention is featured by comprising image pick-up means for shooting a subject in a desired direction and illumination means fixed to a predetermined portion of the image pick-up means and having an illuminating direction substantially coincident with the shooting direction of the image pick-up device.

The illumination means may include a cold-cathode tube arranged such that it surrounds an outer periphery of the predetermined portion of the image pick-up means.

Further, the illumination means may further include a reflector, which substantially encloses the cold-cathode tube and emits illumination light including direct light from the cold-cathode tube and light reflected thereby in a predetermined direction and a sheet member for scattering and diffusing the illumination light emitted from the reflector.

The cold-cathode tube may be a circular type cold-cathode tube.

The image pick-up device may further include an arm for supporting the image pick-up means, auxiliary illumination means housed in the arm for illuminating the subject and switch means for switching illumination between the illumination means and the auxiliary illumination means.

In the latter case, the auxiliary illumination means may include a linear type cold-cathode tube, a reflector, which substantially encloses the linear type cold-cathode tube and emits illumination light including direct light from the linear type cold-cathode tube and light reflected thereby in a predetermined direction, and support means for rotatably supporting the reflector of the auxiliary illumination means.

In the present invention, the illumination means is fixed to the predetermined portion of the image pick-up device in such the way that the illuminating direction thereof is substantially coincident with the shooting direction of the image pick-up means. According to this construction, the illuminating direction is always the same as the direction of the image pick-up means. Therefore, the operator is required to regulate only the shooting direction of the image pick-up means without regulation of the illuminating direction. Further, the arm does not become obstacle in changing the subject since only the arm for supporting the image pick-up means is required, unlike the image pick-up device shown in FIG. 1.

When an interior of a cylindrical subject is shot by the image pick-up device having the illumination means composed of the cold-cathode tube substantially surrounding the outer periphery of the predetermined portion of the image pick-up means, light from the cold-cathode tube reaches the interior. Therefore, it is possible to clearly pick up an image of the interior of the cylindrical subject.

With using the sheet member in the image pick-up device, the amount of light emitted from the illumination means can be made uniform by scattering and diffusing light emitted from the reflector by means of the sheet member.

With using the auxiliary illumination means, the illumination system is switched to the auxiliary illumination means when the illumination means causes halation. The illuminating direction of the auxiliary illumination means is much different from the shooting direction of the image pick-up means. Therefore, even if light from the auxiliary illumination means is regularly reflected by the subject, the reflected light is not incident on the image pick-up means. Therefore, halation does not occur.

### BRIEF DESCRIPTION OF THE DRAWINGS

FIG. 1 shows a conventional image pick-up device;

FIG. 2 shows another conventional image pick-up device;

FIG. 3 shows an image pick-up device according to an embodiment of the present invention;

FIG. 4 is a cross sectional view of a portion including an image pick-up unit and a circular type cold-cathode tube shown in FIG. 3;

FIG. 5A is a plan view of a circular type cold-cathode fluorescent lamp as an example of the circular type cold-cathode tube shown in FIG. 3;

FIG. 5B is a side view of the circular type cold-cathode fluorescent lamp shown in FIG. 3;

FIG. 6A is a front view of a support illumination unit shown in FIG. 3;

FIG. 6B is a plan view of the support illumination unit shown in FIG. 6A;

FIG. 6C is a cross section taken along a line I-I in FIG. 6A;

FIG. 7 illustrates light incident on a cylindrical subject in the image pick-up device shown in FIG. 3; and

FIG. 8 illustrates an embodiment of use of the image pick-up device shown in FIG. 3.

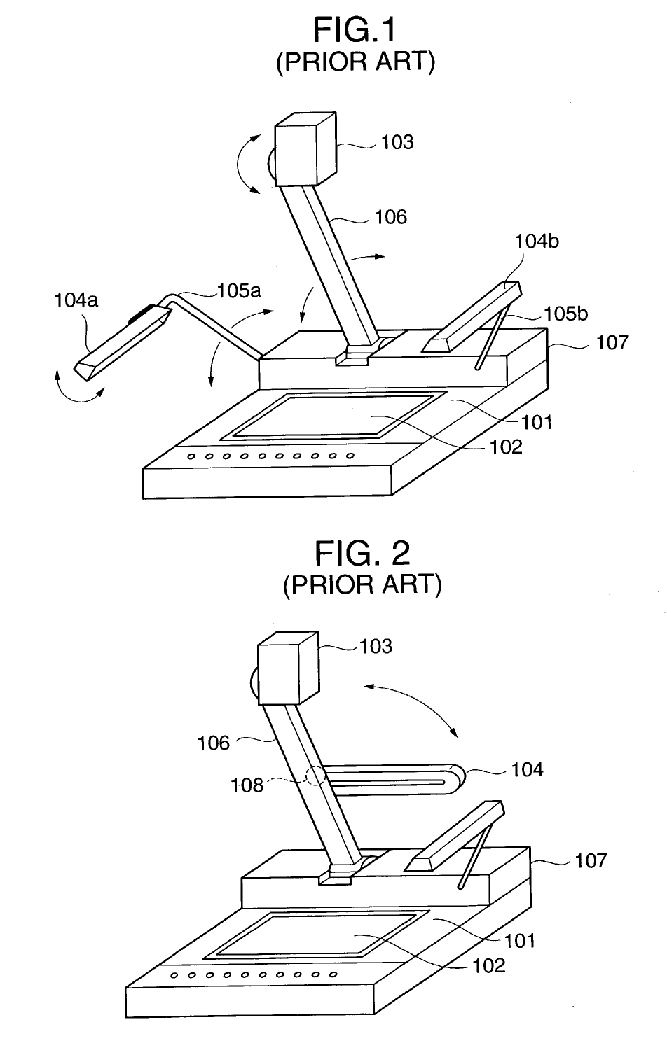

### DETAILED DESCRIPTION OF THE PREFERRED EMBODIMENTS

Preferred embodiments of the present invention will be described with reference to the drawings.

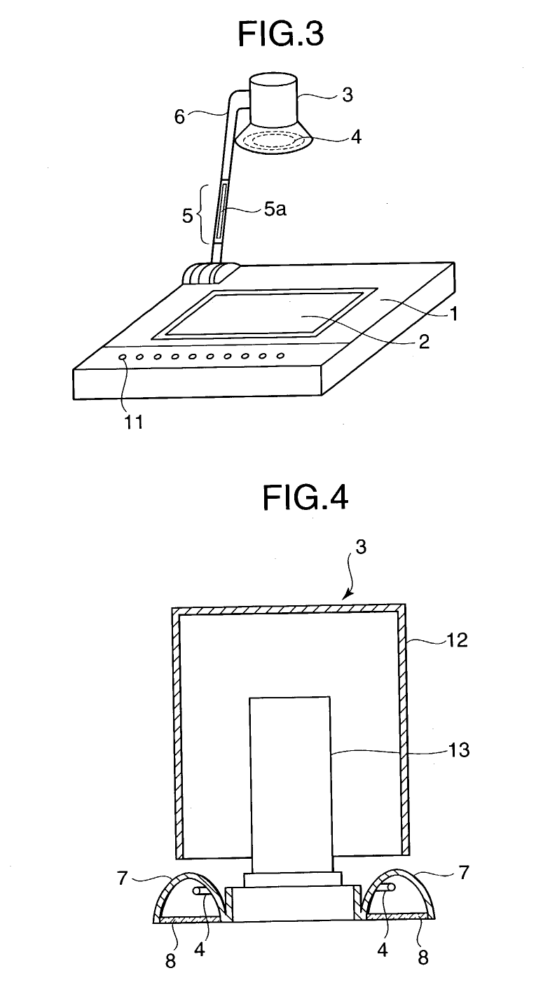

FIG. 3 shows an image pick-up device according to an embodiment of the present invention. The image pick-up device shown in FIG. 3 includes a substantially square subject mounting table 1 on which a subject 2 is mounted, an image pick-up unit 3 for picking up an image of the subject 2 vertically, a circular type cold-cathode tube 4 for illuminating the subject 2, an arm 6 for supporting the image pick-up unit 3 and a support illumination unit 5 provided in a predetermined position of the arm 6 and composed of a linear type cold-cathode tube 5a. The arm 6 is mounted on a predetermined one of corner portions of the subject mounting table 1 and is rotatable about the mounting portion in predetermined directions.

The image pick-up unit 3, which may be constructed with a CCD camera, is rotatably mounted on an upper end portion of the arm 6. The circular type cold-cathode tube 4 is mounted on a front side of. the image pick-up unit 3 in such a way that the shooting direction of the image pick-up unit 3 becomes the same as the illuminating direction of the circular type cold-cathode tube 4. By integrally arranging the image pick-up unit 3 and the circular type cold-cathode tube 4 in this manner, the subject 2 to be shot by the image pick-up unit 3 is always illuminated uniformly by the circular type cold-cathode tube 4. Incidentally, in order to prevent light from the circular type cold-cathode tube 4 from being directly incident on an image picking up plane of the image pick-up unit 3, the circular type cold-cathode tube 4 has to be arranged behind a front plane of the image pick-up unit 3 or means for preventing direct light emitted by the cold-cathode tube 4 from being incident thereon should be provided.

The support light source unit 5 is provided to prevent halation from occurring and can be replaced by the circular type cold-cathode tube 4 on demand by using a switch 11 provided in a predetermined portion of the subject mounting plate 1. Assuming a case where a reflective original such as OHP (Over Head Projector) sheet is mounted on the subject mounting plate 1 as the subject 2, an image picked up by the image pick-up unit 3 becomes a blurred white image due to regular reflection of light emitted by the circular type cold-cathode tube 4 by the reflective original. This phenomenon is called halation.

For example, cold-cathode fluorescent lamps may be used as the circular type cold-cathode tube 4 and the linear type cold-cathode tube 5a, respectively. The cold-cathode fluorescent lamp is similar to the well known fluorescent lamp and includes a glass tube, electrodes, filler gas, mercury and a fluorescent member. However, the electrode of the cold-cathode fluorescent lamp is not a filament but a metal member. Since the cold-cathode fluorescent lamp uses not filament but metal member, its duration is long (about 7 to 10 times the duration of the usual fluorescent lamp) and miniaturization thereof is possible. Due to such features of the cold-cathode fluorescent lamp, it is easily possible to realize the fixing structure to the image pick-up unit 3 shown in FIG. 3. Further, since heat generation of the cold-cathode fluorescent lamp itself is small, thermal influence on the image pick-up unit 3 is small.

Now, the illumination system using the circular type cold-cathode tube 4 will be described in detail with reference to FIG. 4, which is a cross section of the image pick-up unit 3 and the circular type cold-cathode tube 4 shown in FIG. 3.

The image pick-up unit 3 includes a casing 12 and a lens assembly (ASSY) 13 housed in the casing 12 for picking up an image of the subject 2. A required image data (digital data) such as zoomed image of the subject 2 can be read in through the lens assembly 13. A front portion of the lens assembly 13 protrudes from the casing 12.

The circular type cold-cathode tube 4 and an annular reflector 7 are provided in such a manner that they surround the front portion of the lens assembly 13 protruded from the casing 12. The annular reflector 7 has a generally reversed-U shaped cross section and the circular type cold-cathode tube 4 is arranged within the annular reflector 7. The annular reflector 7 is fixed to a predetermined portion of the protruded portion of the lens assembly 13 by means of, for example, screws (not shown). An open area (light emitting area) of the annular reflector 7 is covered by an annular scattering/diffusing sheet 8 provided in substantially the same plane as the front surface of the lens assembly 13. A reflecting material forming the annular reflector 7 is, for example, polycarbonate (PC) of high reflection grade.

Direct light from the circular type cold-cathode tube 4 and lights reflected by the annular reflector 7 are emitted from the open area of the annular reflector 7 in a predetermined direction. Lights emanating from the open area is scattered and diffused by the annular scattering/diffusing sheet 8. Therefore, it is possible to uniformly illuminate the subject 2 with soft light.

The annular reflector 7 is fixed to the protruded portion of the lens assembly 13 such that the illuminating light emitted from the open area is directed along an optical axis of the lens assembly 13. Therefore, the direction of the illuminating light is always coincident with the direction of the image pick-up unit 3. Preferably, this illumination system is set such that a whole area covered by the image pick-up unit 3 is illuminated by light from the annular reflector 7. In such case, an area to be shot can always be illuminated by light from the annular reflector 7 regardless of the shooting direction of the image pick-up unit 3.

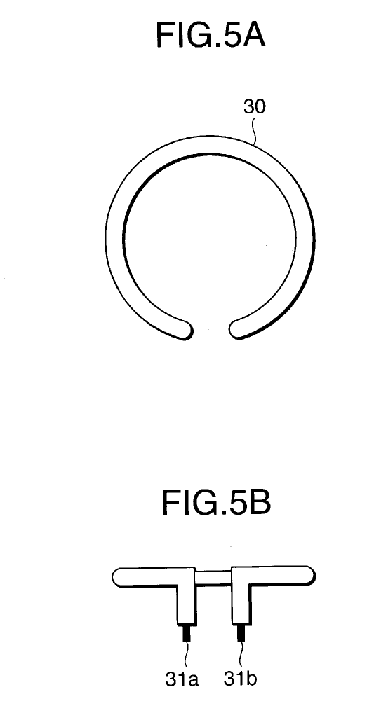

FIG. 5A is a plan view of a circular type cold-cathode fluorescent lamp as an example of the circular type cold-cathode tube 4 and FIG. 5B is a side view of the same. As shown in FIG. 5A and FIG. 5B, the circular type cold-cathode fluorescent lamp includes a circular glass tube 30 filled with a suitable amount of mercury and inert gas. Both end portions of the circular type glass tube 30 are bent down and electrodes 31a and 31b are provided in the end portions, respectively. An inner wall of the circular glass tube 30 is painted with fluorescent material. When a high voltage is applied between the electrodes 31a and 31b, electrons are emitted from the electrodes 31a and 31b. Mercury molecules are excited by the thus emitted electrons and ultraviolet ray emitted from the excited mercury molecules in the glass tube 30 irradiates the fluorescent material on the inner wall of the circular type cold-cathode fluorescent lamp. Thus, the circular type cold-cathode fluorescent lamp emits light.

When the circular cold-cathode fluorescent lamp shown in FIG. 5A and FIG. 5B is used, luminance of the end portions thereof, in which the electrodes 31a and 31b are provided, becomes substantially lower than the other portion thereof since the end portions do not emit light. According to the construction shown in FIG. 4, in which the annular scattering/diffusing sheet 8 is provided, the reduction of luminance of the electrode portions is relaxed, so that the subject 2 can be illuminated uniformly.

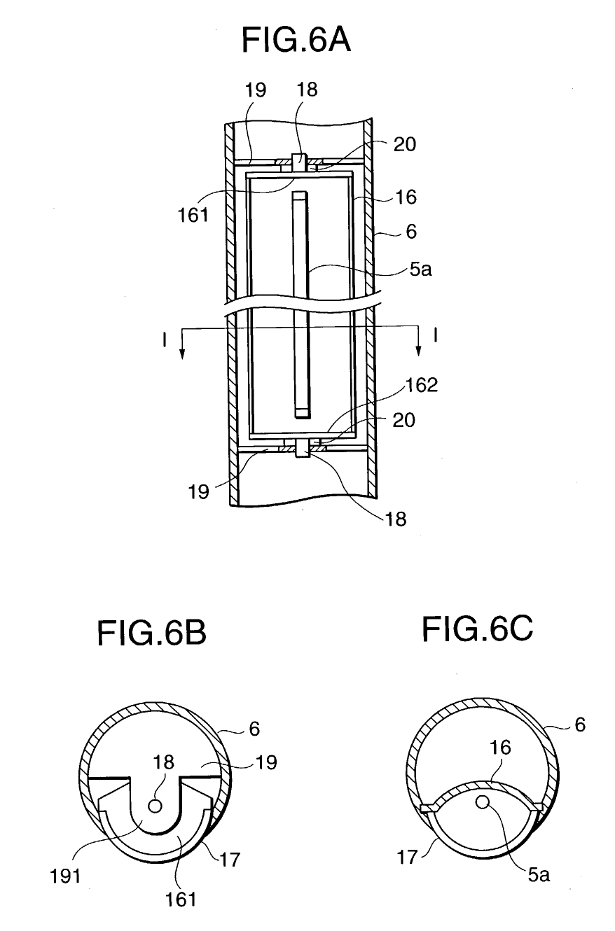

Now, the illuminating system of the support light source unit 5 will be described in detail. FIG. 6A and FIG. 6B are a front view and a plan view of the support light source unit 5 shown in FIG. 3 and FIG. 6C is a cross section taken along a line I-I in FIG. 6A.

The linear type cold-cathode tube 5a is provided in a linear type reflector 16 having a generally U shape cross-section. A light emitting area (open area) of the linear type reflector 16 is covered by an acrylic lens 17. Direct light from the linear cold-cathode tube 5a and lights reflected by the linear reflector 16 pass through the lens 17. The lens 17 functions to uniformly illuminate the subject 2 with light from the linear type cold-cathode tube 5a and to protect the linear cold-cathode tube 5a.

An upper plate 161 and a lower plate 162, which have respective axial protrusions 18, are fixed to an upper portion and a lower portion of the linear reflector 16, respectively. A pair of support plates 19 each having a bearing for receiving the axial protrusions 18 are provided fixedly within the arm 6 to support the reflector housing the linear cold-cathode tube 5a. In detail, the axial protrusion 18 provided on the upper plate 161 of the linear reflector 16 is fitted in the bearing formed in a tab 191 of the upper support plate 19. A resilient O-ring 20 is provided between the bearing of the upper support plate 19 and the protrusion 18 formed on the upper plate 161. Similarly, the axial protrusion 18 provided on the lower plate 162 of the linear reflector 16 is fitted in the bearing formed in a tab 191 of the lower support plate 19. A resilient O-ring 20 is provided between the bearing of the upper support plate 19 and the protrusion 18 formed on the lower plate 162. Therefore, the linear reflector 16 is rotatable about the axial protrusions 18 received in the upper and lower bearings of the upper and lower support plates 19 and rotation angle thereof can be freely fixed by resiliency of the O-ring 20. Although the axial protrusions 18 and the linear cold-cathode tube 5a are preferably coaxial, the present invention is not limited thereto.

In the structure of the support light source shown in FIG. 6A to FIG. 6C, the support light source unit 5a does not become obstacle in operating the arm 6 since the support light source unit 5a is housed within the arm 6. Further, since the linear reflector 16 is rotatable about the axial protrusions 18 within a certain range, an illumination angle of the support light source can be regulated within a certain range in illuminating the subject 2.

Operational merits of the image pick-up device according to the described embodiment will be described briefly.

An operator mounts a desired subject 2 on the subject mounting plate 1. In the construction shown in FIG. 3, the single arm 6 is arranged at the one corner of the subject-mounting plate 1 and, therefore, the arm 6 does not constitute obstacle in mounting the subject 2 on the subject-mounting plate 1. Even when the support light source unit 5a is used in order to avoid halation, the support light source unit 5a does not constitute an obstacle during the operation since the support light source unit 5a is housed in the arm.

When the subject 2 mounted on the subject mounting plate 1 is shot by the image pick-up unit 3, the subject 2 is uniformly illuminated by light from the circular type cold-cathode tube 4 by merely directing the image pick-up unit 3 to the subject 2. Therefore, in shooting the subject 2, the operator is not required to regulate the illumination angle of the circular type cold-cathode tube 4, resulting in that the operability is improved.

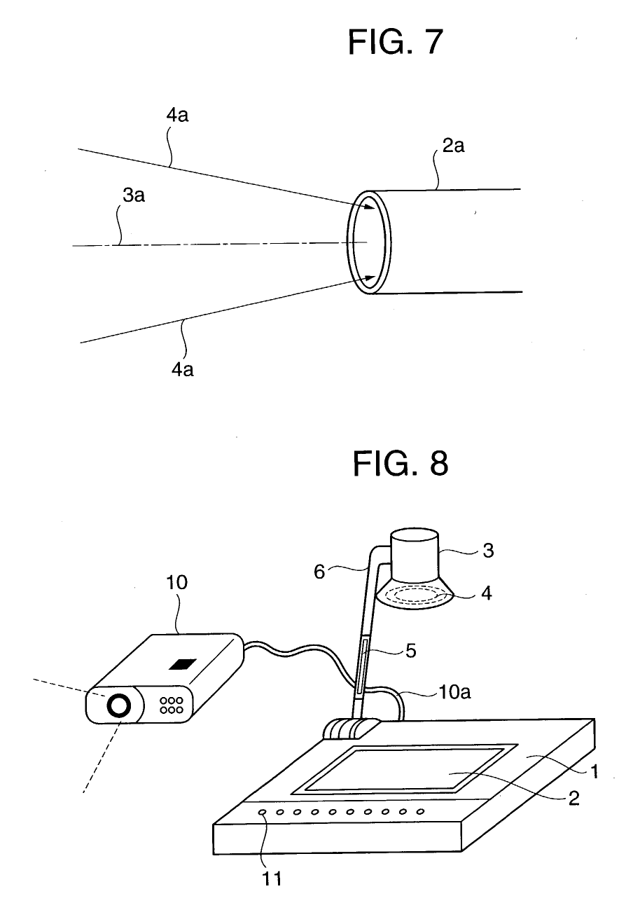

When the subject 2 is a cylindrical subject 2a, it is possible to clearly illuminate an inside of the cylindrical subject. FIG. 7 illustrates illumination light incident on the cylindrical subject. As is clear from FIG. 7, light portion 4a of the illumination light from the circular type cold-cathode tube 4, which makes a predetermined angle with respect to an optical axis 3a of the image pick-up unit 3, is incident on the inside of the cylindrical subject 2a through a circular opening area of the cylindrical subject 2a. Therefore, the inside of the cylindrical subject 2a is uniformly and clearly illuminated by the light portion 4a.

Now, a utilization of the image pick-up device according to this embodiment shown in FIG. 3 will be described in detail with reference to FIG. 8.

An output terminal (not shown) for outputting an image data (digital data) obtained by the image pick-up unit 3 to a projector 10 is provided in a backside portion of the subject mounting portion of the image pick-up device. The output terminal is connected to a video input terminal (not shown) of the projector 10 through a communication cable 10a.

When a desired subject 2 is mounted on the subject mounting table 1 and shot by the image pick-up unit 3, the image data of the subject 2 is transmitted from the image pick-up device to the projector 10. In the projector 10, the image data is enlarged and projected onto a screen (not shown).

In a case where the subject 2 is a reflective original such as an OHP sheet, halation is prevented by switching the light source unit from the circular cold-cathode light source unit 4 to the support light source unit 5. In switching the light source unit, it is necessary to obtain an optimal illumination by regulating the angles of the linear reflector 16 shown in FIG. 6A to FIG. 6C and the arm 6.

In the image pick-up device according to the described embodiment, the illumination means fixed to the image pickup unit 3 is not limited to the circular type cold-cathode tube 4. The illumination means may be any, provided that it is fixed to a predetermined portion of the image pick-up unit 3 in such a way that the illuminating direction thereof to the subject 2 is substantially coincident with the shooting direction of the image pick-up unit 3. For example, the illumination means may be a generally U shape cold-cathode tube, a linear cold-cathode tube or a combination thereof and may be arranged such that it surrounds a predetermined portion of the image pick-up unit 3.

Further, in the construction shown in FIG. 4, the circular type cold-cathode tube 4 may be a plurality of circular type cold-cathode tubes having different diameters. In such case, it is possible to increase an amount of light illuminating the subject to thereby acquire a clearer image.

As described hereinbefore, since it is enough to regulate only the shooting direction of the image pick-up unit without need of regulating the illuminating direction according to the present invention, it is possible to provide the image pick-up device having higher operability compared with the conventional image pick-up device.

Further, since only one arm for supporting the image pick-up unit is required, the subject mounting plate can be utilized efficiently and the design of the image pick-up device can be simple without degrading the appearance thereof.

Further, since the illumination light can reach a portion of a subject such as an inside of a cylindrical subject, which is impossible by the conventional device, various subjects can be shot.

What is claimed is:

1. An image pick-up device comprising:
an image pick-up unit for shooting a subject in a desired direction; and
a light source unit fixed to a predetermined portion of said image pick-up unit in such a way that an illuminating direction of said light source unit is substantially coincident with a shooting direction of said image pick-up unit.

2. An image pick-up device as claimed in claim 1, wherein said light source unit includes a cold-cathode tube arranged to surround a predetermined portion of said image pick-up unit.

3. An image pick-up device as claimed in claim 2, wherein said light source unit includes a reflector housing said cold-cathode tube for reflecting light from said cold cathode tube and emitting reflected light in a predetermined direction and a sheet member for scattering and diffusing light emitted from said reflector.

4. An image pick-up device as claimed in claim 2, wherein said cold-cathode tube is a circular cold-cathode tube.

5. An image pick-up device as claimed in claim 1, further comprising an arm for supporting said image pick-up unit, an auxiliary light source unit housed in said arm for illuminating said subject and a switch unit for switching between said light source unit and said auxiliary light source unit.

6. An image pick-up device as claimed in claim 5, wherein said auxiliary light source unit includes a linear cold-cathode tube, a reflector housing said linear cold-cathode tube for reflecting light from said linear cod-cathode tube and emitting light in a predetermined direction and a support portion for rotatably supporting said reflector.
